(19) United States
(12) Patent Application Publication
(10) Pub. No.: US 2006/0202486 A1
(43) Pub. Date: Sep. 14, 2006

(54) Motor vehicle door lock

(75) Inventor: Ludger Graute, Essen (DE)

Correspondence Address: MATTHIAS SCHOLL, 14781 MEMORIAL DRIVE, SUITE 1319, HOUSTON, TX, 77079, US

(73) Assignee: KIEKERT AKTIENGESELLSCHAFT, HEILIGENHAUS (DE)

(21) Appl. No.: 10/555,202

(22) PCT Filed: Apr. 30, 2004
(86) PCT No.: PCT/DE04/00907

§ 371 Date: Nov. 1, 2005

(30) Foreign Application Priority Data
May 8, 2003 (DE) 103 20 457.1

(51) Int. Cl. E05C 3/06

(52) U.S. Cl. 292/216

(57) ABSTRACT

The object of the present invention is a vehicle door latch containing a locking mechanism (1, 2), mainly comprising a catch (1) and pawl (2). In addition, a locking pin (5), moving into the inlet opening (6) and interacting with the catch (1), is provided. The inlet opening (6) contains at least one soundproofing element (8) for the locking pin (5). According to the invention, the soundproofing element (8) also operates as a cushioning stop for the catch (1).

The invention refers to a vehicle door latch containing a locking mechanism comprising mainly a catch and pawl and a locking pin, moving into an inlet opening and interacting with the catch, with the inlet opening containing at least one soundproofing element for the locking pin.

A vehicle door latch of the type described above is disclosed in EP 0 336 034 A2 or WO 95/10679 A1. In the reference system of the vehicle door latch, the soundproof ing element ensures that the locking pin, moving into the inlet opening and then held by the catch in its primary position, is fixed in this position with a minimum of noise. In general, a relative movement is carried out between the locking pin and the inlet opening, with the locking pin usually being fixed to the vehicle body, whilst on the other hand a vehicle door and with it the respective vehicle door latch are moved.

Apart from the described noise reduction of the soundproofing element, this component ensures that a respective vehicle door can be closed with excess stroke, so that the pawl engages correctly into the primary position of the catch. Such soundproofing elements have a proven record and are frequently used in practical applications.

We also refer to EP 1 136 640 A1, providing, however, no soundproofing element in the inlet opening for the locking pin, but instead three individual rubber buffers assigned to the catch.

A locking mechanism can, for instance, be electrically opened, by the pawl being lifted by a motor or another means, so that the catch is released and carries out a spring-driven rotation movement around its axis. In order to limit this rotation movement, separate stops can be provided inside the latch housing.

The invention is based on the technical problem of further developing a vehicle door latch of the above type, in such a way that the design is simplified and, in particular, the number of the required components is reduced.

To solve this technical problem, a vehicle door latch of this type is characterized by the soundproofing element also operating as a cushion for the catch. In other words, the soundproofing element has two functions. On one hand, as a noise-reducing stop for the locking pin and, on the other hand, as the cushion for the catch. In order to restrict the rotation movement of the catch, a stop or limit stop can be provided in the back plate or latch housing. In general, the soundproofing element or the cushion for the catch can also carry out the function of a stop and restrict the opening movements of the catch. This means that the rotation movements of the catch after lifting of the pawl, as described above and regularly associated with an electrical and mechanical opening of the locking mechanism, are restricted by a separate stop or limit stop or by the soundproofing element.

In any case, the catch is not only fixed during an opening movement and is, so to speak positioned in an opened state, but at the same time, the cushion ensures that the catch does not move directly against a hard stop during the described opening process but that instead, its movement is cushioned. At the same time, the soundproofing element ensures that the catch positioned in its open position is acoustically uncoupled from an obligatory latch housing, so that no rattling noise can be heard. This also prevents that the electric opening or opening movements of the catch initiated in any other manner generate a noise when moving against a stop. The soundproofing element does actually prevent such stop-related noises.

In a proven embodiment, the soundproofing element is designed as a L-shaped insert for the inlet opening. One L-leg of the L-shaped soundproofing element may be designed as a holding leg and the other L-leg as a cushioning leg for the locking pin and the catch. The cushioning leg provides not only a stop for the locking pin but also a stop for the catch.

For this purpose, the inside of the cushioning leg contains a locking pin stop face and the outside a catch stop face. The locking pin stop face is located at the end of the inlet opening, whilst the catch stop face protrudes over the inlet opening on the outside.

In order to be able to easily position the soundproofing element opposite the inlet opening, the holding leg contains recesses, guarantying a tilt-free and easy crosswise insertion into a receiving groove. The receiving groove is arranged mainly parallel to the inlet opening. It is, in most cases, located below the inlet opening and forms together with the inlet opening an inlet insert for a latch housing.

This means that this inlet insert, which may be a molded plastic part, can be inserted into the latch housing, not only accommodating the locking mechanism but also the usual lever apparatus, latched to it or connected in another manner. Prior to this, the soundproofing element was inserted into the receiving groove of the inlet insert, with the recesses on the holding leg ensuring the described easy crosswise insertion.

The cushioning leg, on the other hand, protrudes at least partially from the inlet insert for the catch to move against with a stop, projection, etc. and receives, at the same time, the required cushioning. The invention also suggests that the soundproofing element contains a, in most cases, fitted and temporarily-closed cover for the insertion of, for instance, an emergency locking tool. The emergency locking tool (in the simplest form an ignition key) is able to move a locking lever or generally the locking lever mechanism into the “locked” position if, for instance, the central locking has failed.

As a result, a vehicle door latch is provided that contains a prefabricated inlet insert for the latch housing, whose soundproofing element carries out at least two functions. On one hand, the soundproofing element ensures that the locking pin meets a limit stop and that, in particular, in the primary position, the catch is not only safely positioned but also, at the same time, fixed without nearly any noise. This is because the soundproofing element is generally made of a thermoplastic plastic, in particular, polyurethane (PUR) or rubber. Shore-A hardnesses of 60 to 90 and preferably of 70, have been proven to be advantageous.

On the other hand, the soundproof ing element with its cushioning leg protruding over the inlet insert provides the additional function of acting as a cushioning stop for the catch. For this purpose, the catch contains a rib, a projection, a journal or a similar stop, which lies against the cushioning leg upon completion of its opening movement. This causes the catch to correctly assume its open position with, at the same time, the opening movement being stopped and maintained practically without any noise, so that the vehicle door latch according to the invention produces hardly any externally audible noise or transmits structure-borne noise via the vehicle body. These are the main advantages of the invention.

Below, the invention is explained in detail with reference to a drawing representing only one embodiment of the invention, in which:

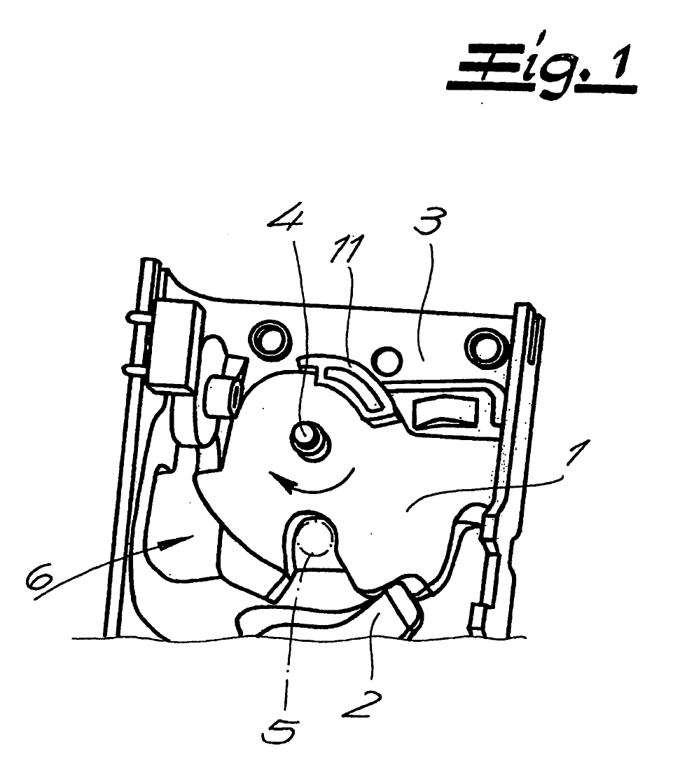

FIG. 1 shows the vehicle door latch of the invention without inlet insert with a top view of the locking mechanism and

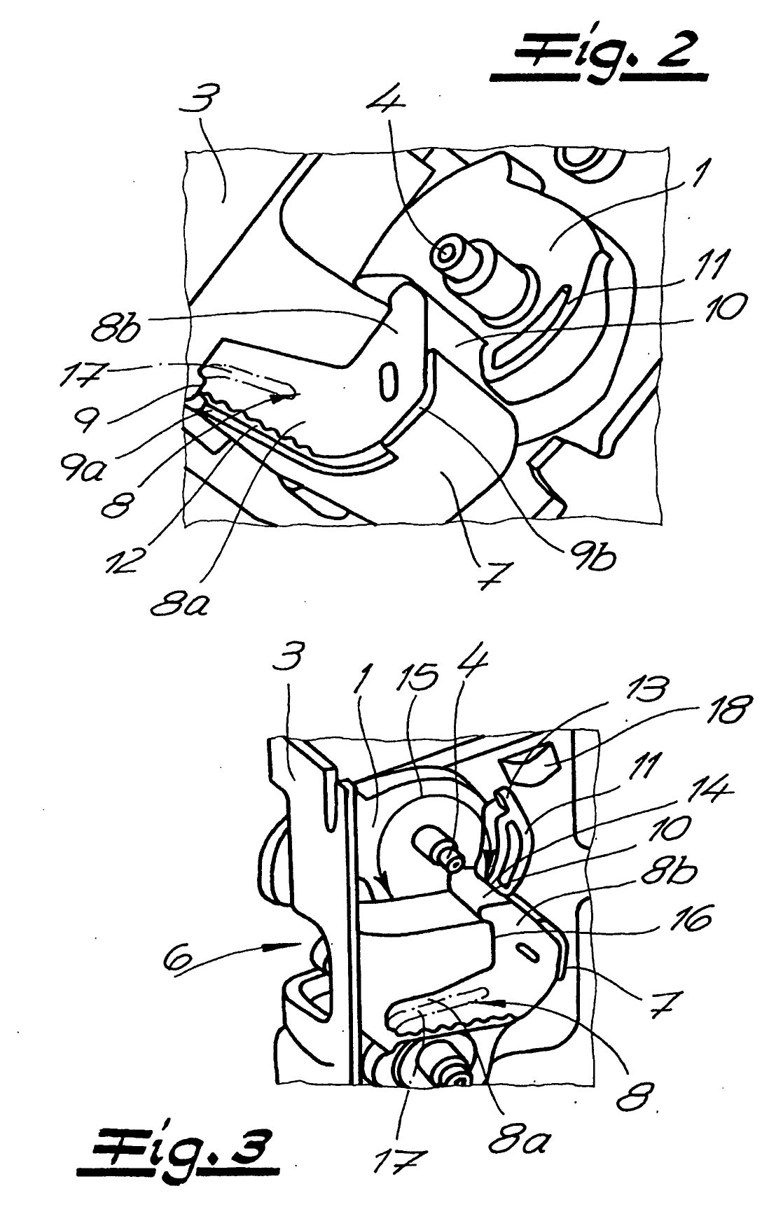

FIGS. 2 and 3 show different views of the inlet insert.

The figures contain a vehicle door latch, showing mainly a locking mechanism 1, 2 comprising catch 1 and pawl 2, which are arranged together in a latch housing or back plate 3. As soon as the pawl 2 is lifted out, the catch 1, as shown in FIG. 1 turns clockwise, as indicated by the arrow, around its axis 4 out of the indicated primary position by means of a spring. At the same time, a locking pin 5—only indicated—is released so that the respective vehicle door—not shown—can be opened in the usual manner. The lifting out of the pawl 2 can be achieved by purely mechanical means via an actuating lever mechanism—not shown—or by means of a motor, in particular an electric motor, as detailed under electric opening, described above.

In order to return the catch 1 to its first or primary position, the locking pin 5 in the reference system of the vehicle door latch, moves into an inlet opening 6, shown in particular in FIGS. 2 and 3. This inlet opening 6 is defined by an inlet insert 7, which preferably can be designed as a molded plastic part. The inlet insert 7 is inserted in the latch housing or the back plate 3 and can, for instance, be connected to it by latching or another means. Apart from the inlet opening 6, the inlet insert 7 contains a receiving groove 9 for a soundproofing element 8.

The soundproofing element 8 can, for instance, be made from thermoplastic plastic, according to the PUR (polyurethane) embodiment. It has an L-shaped form with a long L-leg 8a and a short L-leg 8b. The long L-leg 8a is designed as a holding leg 8a and generally serves to support the locking pin 5 compared to the catch 1. To assist this process, a spring lip 17 may be molded to the holding leg 8a, extending from the holding leg 8a inwards within the inlet insert 7. In principle, the locking pin 5 can, however, also lie directly against the short L-leg 8b. The object of the invention naturally also covers a combined version. In one way or another, the long L-leg 8a, the short L-leg 8b and, where applicable, the spring lip 17 ensure that the locking pin 5 is correctly held and guided into the inlet opening 6 with a minimum of noise.

The inlet opening 6 in the inlet insert 7 has a funnel or conical shape and is restricted at its end side by the short L-leg or the cushioning leg 8b. Logically, the locking pin 5 lies against the cushioning leg 8b in the primary position of catch 1 shown in FIG. 1, said cushioning leg also restricting the movement of the locking pin 5 and providing, at the same time, a low-noise fixing in the primary position of the catch 1.

The receiving groove 9 in the inlet insert 7 is also L-shaped, with its short L-leg 9b being open towards the top, whilst the long L-leg 9a of receiving groove 9 accommodates the long L-leg 8a or holding leg 8a of the soundproofing element 8. Because of the open shape of the L-legs 9b of the receiving groove 9, the short L-leg 8b or the cushioning leg of the soundproofing element 8 is able to protrude at least partially from the inlet insert 7, as clearly recognizable in FIGS. 2 and 3.

This end of the cushioning legs 8b of the soundproofing element 8 protruding from the inlet insert 7, defines a catch stop face 10. As after completion of its opening movement, the catch 1 lies, preferably with a projection 11—a molded rib 11 according to the embodiment—against the respective catch stop face 10. In principle, the catch stop face 10 can alternatively or additionally contain a stop or limit stop 18 for the catch 1, arranged in the latch housing or back plate 3. This limit stop 18 restricts an overtravel movement of the catch 1.

In order to be able to correctly position the long L-leg 8a or holding leg 8a of the soundproofing element 8 within the receiving groove 9, the holding leg 8a contains recesses 12, allowing easy crosswise insertion of the holding leg 8a. Catch 1 may also contain a plastic casing, for minimizing any noise when reaching the opening position of the catch 1 shown in FIGS. 2 and 3 and also in the primary position according to FIG. 1. At the same time, the plastic casing ensures that the locking pin 5 interacts with catch 1 with a minimum of friction and noise.

Also, a spring stop 13 on catch 1 is shown, upon which a leg spring—not expressly shown—acts, in order to initiate the described opening movement of the catch 1 in clockwise direction, as shown in FIG. 1 and to initiate such movement with the pawl 2 lifted.

The projection 11 or the rib or stop rib 11 on the catch 1 has a circular arc profile and contains a rib stop face 14, whose gradient corresponds to the inclination of the catch stop face 10 or of the cushioning leg 8b of the soundproofing element 8 when the catch 1 is in open position. Because the stop or the rib 11 protrudes from the catch 1, the inlet insert 7 can be positioned in the immediate vicinity of the catch 1, as the stop or the rib 11 on the whole finds a recess 15 at this point, represented by a circular arc in FIG. 3 and permitting the required movements of the catch 1. At the end side of the inlet opening 6, a locking pin stop face 16 is shown on the inside of the inlet opening 6 on the cushioning leg 8b.

1-10. (canceled)

11. A vehicle door latch with a locking mechanism (1, 2) comprising
a latch housing (3), having an inlet opening (6) for receiving a locking pin (5);
a catch (1);
a pawl (2); and
at least one soundproofing element (8);
wherein at least one said soundproofing element is disposed in said inlet opening (6); and at least one said soundproofing element (8) also acts as a cushion for said catch (1).

12. The vehicle door latch of claim 11, wherein at least one said soundproofing element (8) restricts movements of said catch (1).

13. The vehicle door latch of claim 11, wherein said latch housing (3) comprises a receiving grove (9); and said soundproofing element (8) is an L-shaped insert for said receiving groove (9).

14. The vehicle door latch of claim 11, wherein said soundproofing element (8) comprises a long L-leg (8a) and a short L-leg (8b); said long L-leg (8a) being a support for said locking pin (5) with respect to said catch (1); and said short L-leg (8b) being a stop for said locking pin (5) and a stop for said catch (1).

15. The vehicle door latch of claim 14, wherein said long L-leg (8a) comprises a plurality of recesses (12) allowing for an easy crosswise insertion of said soundproofing element (8) into said receiving groove (9).

16. The vehicle door latch of claim 14, wherein said short L-leg (8b) comprises a locking pin stop face (16) and a catch stop face (10).

17. The vehicle door latch of claim 13, wherein said inlet opening (6) and said receiving groove (9) are disposed substantially parallel to each other.

18. The vehicle door latch of claim 13, wherein said inlet opening (6) and said receiving groove (9) taken together form an inlet insert (7) of said latch housing (3).

19. The vehicle door latch of claim 18, wherein said short L-leg (8b) protrudes at least partially from said inlet insert (7).

20. The vehicle door latch of claim 11, wherein at least one said soundproofing element (8) comprises further a cover for receiving an emergency locking tool.

21. A vehicle door latch comprising
a latch housing (3) having an inlet opening (6);
a catch (1);
a pawl (2);
a locking pin (5) being engaged with said catch (1) within said inlet opening (6); and
at least one soundproofing element (8) being disposed within said inlet opening (6) and also acting as a cushion for said catch (1).

22. The vehicle door latch of claim 21, wherein said soundproofing element (8) reduces the noise created by a movement of said locking pin (5) within the vehicle door latch.

23. The vehicle door latch of claim 21, wherein said soundproofing element (8) reduces the noise created by a movement of said catch (1) within the vehicle door latch.

24. The vehicle door latch of claim 21, wherein said soundproofing element (8) reduces the vibrations created by a movement of said catch (1) within the vehicle door latch.

25. The vehicle door latch of claim 21, wherein said soundproofing element (8) restricts the movement of said catch (1) within the vehicle door latch.

26. The vehicle door latch of claim 22, wherein said soundproofing element (8) restricts the movement of said catch (1) within the vehicle door latch.

27. The vehicle door latch of claim 21, wherein said soundproofing element (8) comprises a long L-leg (8a) and a short L-leg (8b).

28. The vehicle door latch of claim 21, wherein said long L-leg (8a) is a support for said locking pin (5) with respect to said catch (1); and said short L-leg (8b) is a stop for said locking pin (5) and a stop for said catch (1).

29. The vehicle door latch of claim 21, wherein said short L-leg (8b) comprises a locking pin stop face (16) and a catch stop face (10).

30. The vehicle door latch of claim 29, wherein said locking pin stop face (16) is located at the end of said inlet opening (6).

31. The vehicle door latch of claim 29, wherein said catch stop face (10) protrudes over said inlet opening (6).

32. The vehicle door latch of claim 27, wherein said latch housing (3) comprises a receiving grove (9).

33. The vehicle door latch of claim 32, wherein said long L-leg (8a) comprises a plurality of recesses (12) allowing for an easy crosswise insertion of said soundproofing element (8) into said receiving groove (9).

34. The vehicle door latch of claim 32, wherein said inlet opening (6) and said receiving groove (9) are disposed substantially parallel to each other.

35. The vehicle door latch of claim 32, wherein said inlet opening (6) and said receiving groove (9) taken together form an inlet insert (7) of said latch housing (3).

36. The vehicle door latch of claim 35, wherein said inlet insert (7) is made of molded plastic.

37. The vehicle door latch of claim 35, wherein said short L-leg (8b) protrudes at least partially from said inlet insert (7).

38. The vehicle door latch of claim 21, wherein at least one said soundproofing element (8) comprises further a cover for receiving an emergency locking tool.

39. The vehicle door latch of claim 21, wherein said soundproofing element (8) ensures that said locking pin (5) meets a limit stop.

40. The vehicle door latch of claim 21, wherein said soundproofing element (8) ensures that said catch (1) is safely positioned and fixed without nearly any noise.

41. The vehicle door latch of claim 21, wherein said soundproofing element (8) is made of a thermoplastic.

42. The vehicle door latch of claim 21, wherein said thermoplastic is polyurethane or rubber.

43. The vehicle door latch of claim 42, wherein said thermoplastic has a Shore-A hardness of 60 to 90.
